(19) United States
(12) Patent Application Publication
(10) Pub. No.: US 2018/0106530 A1
(43) Pub. Date: Apr. 19, 2018

(54) SOLAR-ASSISTED ELECTRICAL APPLIANCE

(71) Applicant: Haier US Appliance Solutions, Inc., Wilmington, DE (US)

(72) Inventor: Richard DeVos, Goshen, KY (US)

(21) Appl. No.: 15/294,814

(22) Filed: Oct. 17, 2016

(51) Int. Cl. F25D 23/12; H02J 3/38; F25D 11/00; F25B 27/00

(52) U.S. Cl. CPC F25D 23/12; F25B 27/005; F25D 11/00; H02J 3/383

(57) ABSTRACT

A solar-assisted is generally provided herein. The appliance may include an alternating current voltage source, an alternating current component, a direct current component, a rectifier, and a solar panel. The alternating current component may be electrically coupled to the alternating current voltage source. The direct current component may be electrically coupled to the alternating current voltage source. The rectifier may be operably connected between the direct current component and the alternating current voltage source. The solar panel may be electrically coupled to the direct current component and bypassing the rectifier.

### FIELD OF THE INVENTION

The present subject matter relates generally to electrical appliances, and more particularly to electrical appliances having a solar panel for supplying power thereto.

### BACKGROUND OF THE INVENTION

Modern appliances, particularly home appliances such as refrigerators washers, etc. are frequently provided with electronic features such as controllers, clocks, timers, and displays. In many cases, these features are configured to receive a direct current (DC) voltage. Moreover, these features often require continuous electricity throughout the day. Such electricity is generally provided from an alternating current (AC) electrical power system of a home or business. Nonetheless, industry standards and/or government regulations may limit or budget the maximum amount of AC power that an appliance can draw.

In order to limit the amount of AC power drawn from the electrical power system of a home or business, some appliances are configured to operate on power from an alternative or “green” power source. However, these appliances generally require specialized systems and/or inverters to convert the received power to a compatible voltage and frequency for each feature. Such systems can significantly increase the cost and complexity of an appliance. Moreover, the power availability from certain alternative power sources can be unpredictable. For instance, unforeseen or significant cloud coverage can severely limit the amount of available solar energy. Moreover, virtually no solar energy is available during evening hours. As a result, it can be difficult to ensure continuous power and operation from alternative power sources.

Accordingly, an appliance, such as a refrigerator appliance, with features for reducing or limiting the amount of power drawn from an AC power source or system would be advantageous. In particular, it would be advantageous to provide an appliance that was configured to utilize an alternative power source to supplement the power provided to the appliance without significantly increasing the cost or decreasing the efficiency thereof.

### BRIEF DESCRIPTION OF THE INVENTION

Aspects and advantages of the invention will be set forth in part in the following description, or may be obvious from the description, or may be learned through practice of the invention.

In one aspect of the present disclosure an appliance is provided. The appliance may include an alternating current voltage source, an alternating current component, a direct current component, a rectifier, a solar panel, and a voltage regulator. The alternating current component may be electrically coupled to the alternating current voltage source. The direct current component may be electrically coupled to the alternating current voltage source. The rectifier may be operably connected between the direct current component and the alternating current voltage source. The solar panel may be electrically coupled to the direct current component and bypassing the rectifier. The voltage regulator may be electrically coupled between the solar panel and the direct current component.

In another aspect of the present disclosure, a refrigerator appliance is provided. The refrigerator appliance may include a cabinet, a sealed refrigeration loop, an alternating current voltage source, a direct current component, a rectifier, and a solar panel. The cabinet may have an outer surface and an inner surface defining an enclosed chilled chamber. The sealed refrigeration loop may be in communication with the chilled chamber to direct a cooled airflow thereto. The sealed refrigeration loop may include a compressor operable to generate a flow of refrigerant, a condenser disposed downstream of the compressor such that the condenser receives the flow of refrigerant from the compressor during operation of the compressor, an expansion device disposed downstream of the condenser, and an evaporator disposed downstream of the expansion device. The alternating current component may be electrically coupled to the alternating current voltage source. The direct current component may be electrically coupled to the alternating current voltage source. The rectifier may be operably connected between the direct current component and the alternating current voltage source. The solar panel may be electrically coupled to the direct current component and bypassing the rectifier.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of a refrigerator appliance according to exemplary embodiments of the present disclosure.

FIG. 2 provides a rear perspective view of the exemplary refrigerator appliance of FIG. 1.

FIG. 3 provides a schematic view of certain components of the exemplary refrigerator appliance of FIG. 1.

FIG. 4 provides a schematic view of certain components of the exemplary refrigerator appliance of FIG. 1.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In some aspects of the present disclosure, an appliance is provided that includes one or more direct current electrical components and a solar panel. Power may be selectively provided to the direct current electrical from the solar panel or from an alternating power source.

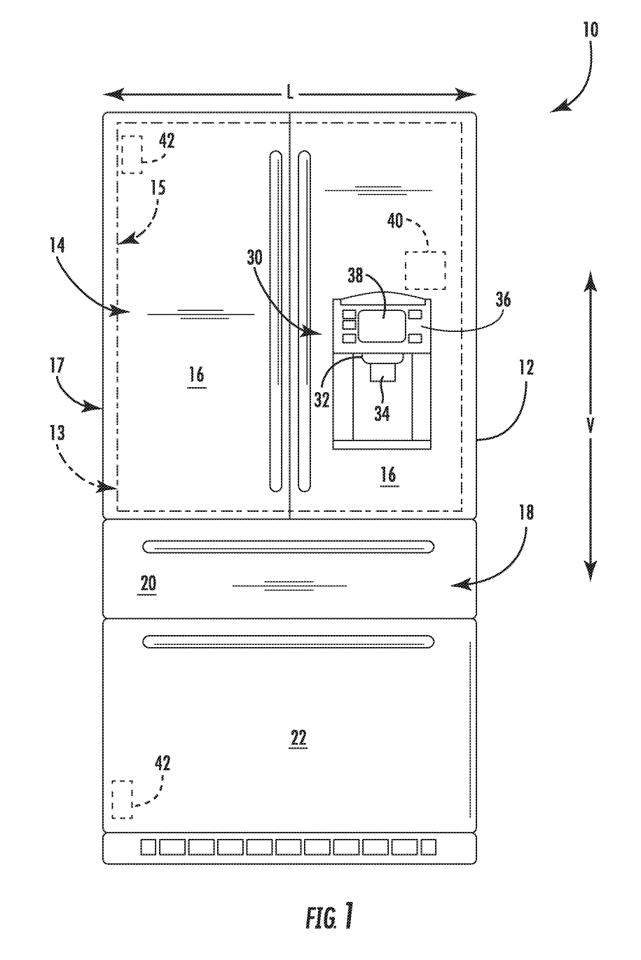

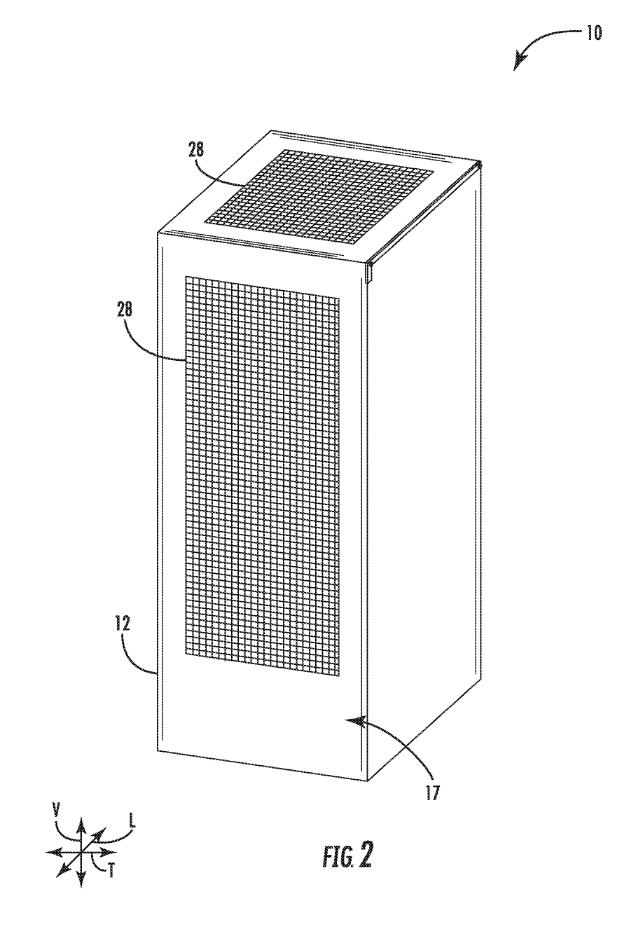

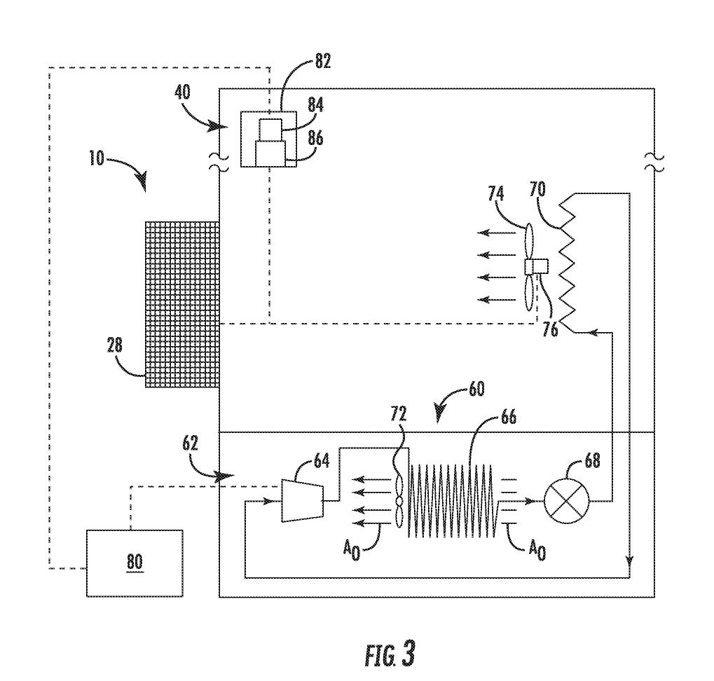

Turning now to the figures, FIGS. 1 and 2 depict a refrigerator appliance 10 that incorporates a sealed refrigeration system 60 (FIG. 3). It should be appreciated that the term “refrigerator appliance” is used in a generic sense herein to encompass any manner of refrigeration appliance, such as a freezer, refrigerator/freezer combination, and any style or model of conventional refrigerator. In addition, it should be understood that the present subject matter is not limited to use in refrigerator appliances. Thus, except as limited by the included claims, different home appliances, such as an oven, washer, dryer, etc. may be provided without departing from the subject matter of the present disclosure.

In the illustrated exemplary embodiment shown in FIGS. 1 and 2, the refrigerator appliance 10 is depicted as an upright refrigerator that includes a cabinet or casing 12 defining an enclosed chilled chamber. Specifically, an inner liner having an outer face 13 and an inner face 15 may define the chilled chamber within cabinet 12. In some embodiments, each of outer face 13 and inner face 15 is at least partially enclosed within an external shell 17 defining an outer surface of appliance 10. Optionally, the chilled chamber includes one or more upper fresh-food compartments 14 and one or more lower freezer compartments 18. Generally, cabinet 12 further defines a vertical direction V, a lateral direction L, and a transverse direction (not pictured). The vertical direction V, lateral direction L, and transverse direction are all mutually perpendicular and form an orthogonal direction system.

As shown in FIG. 2, in some embodiments, one or more solar panels 28 are provided to selectively supply a direct electrical current to one or more components of appliance 10, as will be described in detail below. Solar panel 28 may be a photovoltaic cell configured to generate the direct electrical current from solar energy. In certain embodiments, solar panel 28 is mounted directly to cabinet 12. For instance, solar panel 28 may be fixed to the outer surface of the external shell 17 at a side or top portion of appliance 10. Each solar panel 28 may be attached to the external shell 17 via one or more mechanical fasteners or adhesives. One or more conductive wires, conduits, or busses may electrically couple each solar panel 28 to another component of appliance 10.

Although FIG. 2 illustrates a solar panel 28 positioned on and mounted to cabinet 12, additional or alternative embodiments may include one or more solar panels 28 positioned away from appliance 10. For instance, a separate solar panel 28 (not pictured) may be mounted to an outer roof or platform (e.g., mounted exterior to a house or building) to receive direct sunlight at the separate panel. Conductive wiring or conduit may extend into the interior portion of a house or building and electrically couple each solar panel 28 to appliance 10.

Turning back to FIG. 1, in certain embodiments, refrigerator appliance 10 includes upper fresh-food compartments 14 having doors 16 and lower freezer compartment 18 having upper drawer 20 and lower drawer 22. The drawers 20 and 22 are “pull-out” drawers in that they can be manually moved into and out of the freezer compartment 18, e.g., in the transverse direction T, on suitable slide mechanisms.

Refrigerator appliance 10 may also include a delivery assembly 30 for delivering or dispensing liquid water and/or ice. For instance, the delivery assembly 30 may receive ice from an icemaker (not pictured) disposed in a sub-compartment of the fresh food chamber 14. Delivery assembly 30 includes a dispenser 32 positioned on or mounted to an exterior portion of refrigerator appliance 10, e.g., on one of refrigerator doors 16, 20, 22. Dispenser 32 includes a discharging outlet for accessing ice and liquid water. An actuating mechanism 34, e.g., a paddle, may be mounted below discharging outlet for operating dispenser 32. In alternative exemplary embodiments, any suitable actuating mechanism may be used to operate dispenser 32. For example, dispenser 32 can include an appliance sensor (such as an ultrasonic sensor) or a button rather than the paddle. A control panel 36 is provided for controlling the mode of operation. For example, control panel 36 includes a plurality of user inputs (not labeled), such as a water dispensing button and an ice-dispensing button, for selecting a desired mode of operation such as crushed or non-crushed ice.

Additionally or alternatively, control panel 36 may include a visual display 38 configured to display information regarding the appliance 10 and/or operation thereof. For instance, visual may be one or more light emitting diodes (LEDs) or liquid crystal displays (LCDs) configured to communicate text or otherwise visual signals to a user. Visual display 38 may be operably connected (e.g., by an electrical coupling bus or wire, or by a wireless transmission system) to a controller 40 to receive and/or transmit signals (e.g., display signals) therebetween.

FIG. 3 is a schematic view of certain components of refrigerator appliance 10, including a sealed refrigeration system 60 of refrigerator appliance 10. A machinery compartment 62 contains components for executing a known vapor compression cycle for cooling air. The components include a compressor 64, a condenser 66, an expansion device 68, and an evaporator 70 connected in series (e.g., along a loop) and charged with a refrigerant. As will be understood by those skilled in the art, refrigeration system 60 may include additional components, e.g., at least one additional evaporator, compressor, expansion device, and/or condenser. As an example, refrigeration system 60 may include two evaporators.

During operation, refrigerant flows into compressor 64, which increases the pressure of the refrigerant within refrigeration system 60. This compression of the refrigerant raises its temperature, which is lowered by passing the refrigerant through condenser 66. Within condenser 66, heat exchange with ambient air takes place so as to cool the refrigerant. A condenser fan 72 is used to pull air across condenser 66, as illustrated by arrows A_{O}, so as to provide forced convection for a more rapid and efficient heat exchange between the refrigerant within condenser 66 and the ambient air. Thus, as will be understood by those skilled in the art, increasing air flow across condenser 66 can, e.g., increase the efficiency of condenser 66 by improving cooling of the refrigerant contained therein.

An expansion device (e.g., a valve, capillary tube, or other restriction device) 68 receives refrigerant from condenser 66. From expansion device 68, the refrigerant enters evaporator 70. Upon exiting expansion device 68 and entering evaporator 70, the refrigerant drops in pressure. Due to the pressure drop and/or phase change of the refrigerant, evaporator 70 is cool relative to compartments 14 and 18 of refrigerator appliance 10. Evaporator 70 may be in fluid communication with compartments 14 and 18. As such, cooled air is produced and refrigerates compartments 14 and 18 of refrigerator appliance 10. Thus, evaporator 70 is a type of heat exchanger which transfers heat from air passing over evaporator 70 to refrigerant flowing through evaporator 70. An evaporator fan 74, including an electric motor 76 to motivate rotation thereof, is used to pull air across evaporator 70 and circulated air within compartments 14 and 18 of refrigerator appliance 10.

Optionally, one or more components, such as compressor 64, may be alternating current (AC) components. For instance, compressor 64 may an AC compressor that is electrically coupled to an AC power source 80, such as residential or municipal power source. In some such embodiments, compressor 64 is thus generally configured to operate in response to an alternating electrical current received from the AC power source 80. The AC power source 90 may operate at a standard voltage; such as an average of one hundred and twenty volts (120 V), two hundred and forty volts (240 V), or another standard voltage for a predetermined region, e.g., one hundred volts (100 V) for Japan.

Collectively, the vapor compression cycle components in sealed refrigeration system 60, including associated fans 72, 74 and/or associated compartments are operable to force cold air through compartments 14, 18 (FIG. 1). The refrigeration system 60 depicted in FIG. 3 is provided by way of example only. Thus, it is within the scope of the present subject matter for other configurations of the refrigeration system to be used as well.

In some embodiments, a controller 40, including an electronic circuit board 82, is provided and configured to control one or more operations of appliance 10. For example, electronic circuit board 82 (e.g., motherboard) may be configured to initiate functional operations of appliance 10 based on a stored program, input received from an input selector (not pictured), and/or inputs received from various appliance sensors, such as a temperature sensor 42 (FIG. 1), disposed within cabinet 12 (FIG. 1), e.g., for monitoring conditions therein.

Electronic circuit board 82 generally includes several motherboard components or modules. For example, electronic circuit board 82 may include one or more memory devices 84 and one or more microprocessors 86, such as general or special purpose microprocessors operable to execute programming instructions or micro-control code associated with operations of appliance 10 (FIG. 1). The memory 84 may represent a random access memory (e.g., DRAM), or read only memory (e.g., ROM or FLASH). In one embodiment, the processor 86 executes programming instructions stored in memory 84. The memory 84 may be a separate component from the processor 86 or may be included onboard within the processor 86. Optionally, one or more additional DC components may be provided on electronic circuit board 82, such as a motor for moving or motivating a mechanical drive component. Additionally or alternatively, additional DC components may include one or more display interfaces, door solenoids, ice-maker components (e.g., auger motor), appliance sensors, anti-sweat heaters, wireless communications boards (e.g., Wi-Fi® or BLUETOOTH®), etc.

When assembled, electronic circuit board 82 is operably connected, e.g., electrically coupled to, another portion of appliance 10 to control one or more operations thereof. For instance, in optional embodiments, electronic circuit board 82 is electrically connected to one or more portions of sealed refrigeration system 60 (FIG. 2), e.g., at compressor 64 and/or motor 76 of evaporator fan 74. In turn, electronic circuit board 82 may be configured to control activation and/or operation of sealed refrigeration system 60 (FIG. 2).

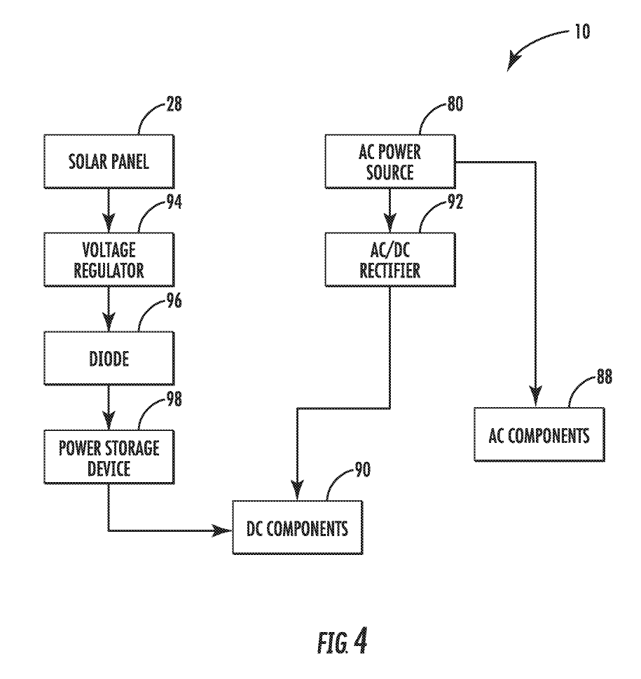

Turning to FIG. 4, is a schematic view of certain components of refrigerator appliance 10. As illustrated, an AC power source 80 is operably connected to an AC component 88. One or more conductive wires, conduits, or busses may electrically couple the AC power source 80 to the AC component 88. As described above, the AC power source 80 may be a residential or municipal power source configured to supply an alternating electrical current at a set voltage (e.g., 115V). Generally, the AC component 88 is an electrically-motivated component configured to operate at the set voltage supplied by the AC power source 80. In some embodiments, the AC component 88 is a compressor 64 of a refrigeration system 60 (FIG. 3), as described above. The AC voltage from the AC power source 80 may induce operation of the compressor 64, thereby initiating refrigerant compression.

In exemplary embodiments, the AC power source 80 is also connected to one or more DC components 90. One or more conductive wires, conduits, or busses may electrically couple the AC power source 80 to the DC component 90. However, a rectifier 92 (e.g., semiconductor diodes, silicon-controlled rectifiers having one or more diodes or thyristors, etc.) is generally provided between the AC power source 80 and the DC component 90 (e.g., in series). As the alternating electrical current is supplied to the DC component 90, rectifier 92 generally operates to convert the supplied alternating electrical current to a direct electrical current. One or more regulator circuits may be included with the rectifier 92 to convert the voltage of the direct electrical current into a suitable voltage for the DC component 90 (e.g., 12 V). In some embodiments, the DC component 90 is an appliance sensor (e.g., sensor 42), a visual display (e.g., display 38), a motor (e.g., motor 76), or a mother board module (e.g., modules 84, 86), as described above.

Solar panel 28 is generally connected to the DC component 90(s). Specifically, one or more conductive wires, conduits, or busses electrically couple solar panel 28 to the DC component 90. As shown, the electrical connection between solar panel 28 and the DC component 90 bypasses rectifier 92. Advantageously, this eliminates the need for an inverter or intermediary component between solar panel 28 and rectifier 92. As described above, solar panel 28 may be a photovoltaic cell configured to generate a direct current from solar energy. Solar panel 28 may be operably connected directly to the DC component 90 (e.g., without connecting to an AC circuit or inverter). During use, solar panel 28 may supply power to the DC component 90 directly, e.g., when solar energy is received at the solar panel 28, thereby generating the direct electrical current.

In some embodiments, a voltage regulator 94 may be disposed between the solar panel 28 and the DC component 90 (e.g., in series). Voltage regulator 94 is generally configured to convert the voltage of the direct electrical current from solar panel 28 into a suitable voltage for the DC component 90. For instance, the voltage at the solar panel 28 may be between five volts (5 V) and twenty-four volts (24 V). Voltage regulator 94 may generally output a separate voltage that is suitable for the DC component 90 (e.g., 12 V). In turn, one or more components (e.g., capacitors, transistors, MOSFET drivers, etc.) may be provided on a circuit to treat the solar direct electrical current before it is delivered to the DC component 90 (e.g., at a new suitable voltage). Moreover, a uni-directional diode 96 may be provided between the solar panel 28 and the DC component 90 (e.g., in series between voltage regulator 94 and the DC component 90). Generally, uni-directional diode 96 is configured to restrict or prevent any direct current from flowing from the DC component 90 to the solar panel 28 and/or voltage regulator 94. In optional embodiments, a power storage device 98 (e.g., battery) may be electrically coupled in series between the voltage regulator 94 and the DC component 90 (e.g., in series).

During use, the appliance 10 may selectively provide a direct electrical current to the DC component 90 from either solar panel 28 or the AC power source 80. For instance, when a suitable level of solar energy is received at the solar panel 28, the direct electrical current generated from solar panel 28 may be automatically directed to the DC component 90. When an insufficient current is available the solar panel 28 and/or power storage device 98, the DC component 90 will receive a direct electrical current from the AC power source 80. Advantageously, this may automatically reduce the AC power consumption of the overall appliance from the AC power supply 80 without ever limiting the use or operation of appliance 10. Moreover, operation of the AC component 88 and/or refrigeration circuit may continue without interruption. Furthermore, selective use current from solar panel 28 may increase the amount of budgeted AC power that can be used for operation of AC components.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An appliance comprising:
an alternating current voltage source;
an alternating current component electrically coupled to the alternating current voltage source;
a direct current component electrically coupled to the alternating current voltage source;
a rectifier operably connected between the direct current component and the alternating current voltage source; and
a solar panel electrically coupled to the direct current component to selectively direct a direct current voltage to the direct current component, the solar panel bypassing the rectifier.

2. The appliance of claim 1, wherein the appliance is a refrigerator.

3. The appliance of claim 1, wherein the direct current component is an appliance sensor, a visual display, a motor, or a motherboard module.

4. The appliance of claim 1, further comprising a cabinet having an outer surface, wherein the solar panel is mounted to the outer surface.

5. The appliance of claim 1, wherein the alternating current component is a compressor.

6. The appliance of claim 1, further comprising a voltage regulator electrically coupled between the solar panel and the direct current component.

7. The appliance of claim 1, further comprising a diode electrically coupled between the solar panel and the direct current component to restrict a current flow from the direct current component to the solar panel.

8. An appliance comprising:
an alternating current voltage source;
an alternating current component electrically coupled to the alternating current voltage source;
a direct current component electrically coupled to the alternating current voltage source;
a rectifier operably connected between the direct current component and the alternating current voltage source;
a solar panel electrically coupled to the direct current component and bypassing the rectifier; and
a voltage regulator electrically coupled between the solar panel and the direct current component.

9. The appliance of claim 8, wherein the appliance is a refrigerator.

10. The appliance of claim 8, wherein the direct current component is an appliance sensor, a visual display, a motor, or a motherboard module.

11. The appliance of claim 8, further comprising a cabinet having an outer surface, wherein the solar panel is mounted to the outer surface.

12. The appliance of claim 8, wherein the alternating current component is a compressor.

13. The appliance of claim 8, further comprising a diode electrically coupled between the solar panel and the direct current component to restrict a current flow from the direct current component to the solar panel.

14. A refrigerator appliance comprising:
a cabinet having an outer surface and an inner surface defining an enclosed chilled chamber;
a sealed refrigeration loop in communication with the chilled chamber to direct a cooled airflow thereto, the sealed refrigeration loop comprising
a compressor operable to generate a flow of refrigerant,
a condenser disposed downstream of the compressor such that the condenser receives the flow of refrigerant from the compressor during operation of the compressor,
an expansion device disposed downstream of the condenser, and
an evaporator disposed downstream of the expansion device;
an alternating current voltage source operably connected to the sealed refrigeration loop;
a direct current component attached to the cabinet and electrically coupled to the alternating current voltage source;
a rectifier operably connected between the direct current component and the alternating current voltage source; and
a solar panel electrically coupled to the direct current component to selectively direct a direct current voltage to the direct current component, the solar panel bypassing the rectifier.

15. The refrigerator appliance of claim 14, wherein the direct current component is an appliance sensor, a visual display, a motor, or a motherboard module.

16. The refrigerator appliance of claim 14, wherein the solar panel is mounted to the outer surface of the cabinet.

17. The refrigerator appliance of claim 14, wherein the alternating current component is electrically coupled to the compressor.

18. The refrigerator appliance of claim 14, further comprising a diode electrically coupled between the solar panel and the direct current component to restrict a current flow from the direct current component to the solar panel.
